(19) United States
(12) Patent Application Publication
(10) Pub. No.: US 2010/0194106 A1
(43) Pub. Date: Aug. 5, 2010

(54) PIPE FOR A PIPELINE COMPRISING A PLURALITY OF PIPES TO BE CONNECTED TOGETHER, AND METHOD OF CONNECTING PIPES OF THIS KIND

(76) Inventor: Dietmar Mayr, Wartberg (AT)

Correspondence Address: HAMMER & ASSOCIATES, P.C., 3125 SPRINGBANK LANE, SUITE G, CHARLOTTE, NC, 28226, US

(21) Appl. No.: 12/511,166

(22) Filed: Jul. 29, 2009

(30) Foreign Application Priority Data
Jul. 31, 2008 (EP) 08013721.9

(51) Int. Cl. F16L 25/10

(52) U.S. Cl. 285/331

(57) ABSTRACT

The pipes according to the invention are distinguished by the fact that they allow a joint to be made without any welding, and sealing rings can be dispensed with when this is done. The pipe according to the invention has an outer coupling portion (2) and in inner coupling portion (3), the outer coupling portion being in the form of a receiving portion and the inner coupling portion being in the form of an insertion portion, to enable two pipes to be connected together in each case. The two coupling portions (2, 3) do not have cylindrical contacting surfaces but curved contacting surfaces. The outer coupling portion has an interior surface which is curved in the longitudinal direction, while the inner coupling portion has an exterior surface which is curved in the longitudinal direction, the surfaces of the inner and outer coupling portions being of different curvatures.

The invention relates to a pipe for a pipeline comprising a plurality of pipes to be connected together, the pipes being joined together without welded joints. The invention also relates to a method of connecting pipes of this kind, the pipes not being welded together.

Pipelines of different designs for liquid or gaseous media are known. The pipelines comprise a plurality of pipes which are joined together when the pipeline is being laid.

When the individual pipes are joined together to form the pipeline, demanding requirements are set for their sealing, particularly when it is gaseous media under pressure which are to be conveyed through the pipeline. These demanding requirements for sealing are generally met by pipelines whose pipes are welded together on site. However, the known welding of pipes of plastics material has the disadvantage that the process is very time-consuming because the pipes have to pass through a relatively long cooling phase after the welding and the ridges of welded material which the welding produces on the inside walls of the pipes have to be removed. What is more, the pipes which are to be welded together have to be fixed in position accurately.

As well as welded joints, what are also known for pipes are insertion joints in which the pipes are connected together by latching into one another. EP 1 004 811 A2 for example describes a pipeline which comprises pipes which are inserted in one another. At their ends, the pipes have latching means by which the pipes are secured together in the longitudinal direction.

DE 200 17 639 U1 proposes that sealing rings be arranged between the latching means of the pipes. However, additional sealing rings may also prove to be a disadvantage. There is for example a risk of the sealing rings slipping out of the groove or being damaged when the pipes are being joined together on site.

EP 1 375 114 A2 describes a method of producing a pipeline from individual pipes in which the pipes are both connected together by latching into one another and are also welded together.

The object underlying the invention is to provide pipes for a pipeline which can be connected together quickly, securely and safely.

This object is achieved in accordance with the invention by virtue of the features of claim 1. Advantageous embodiments form the subject matter of the dependent claims.

The pipes according to the invention are distinguished by the fact that they allow a joint to be made without any welding, and sealing rings can be dispensed with when this is done. The pipes can be safely, securely and easily connected together in this way. The pipes which are connected together meet relatively demanding requirements set for the sealing of the pipeline.

The pipe according to the invention has an inner coupling portion which is at the front in the drawings and an outer coupling portion which is at the rear in the drawings, the inner coupling portion being in the form of an insertion portion and the outer coupling portion being in the form of a receiving portion, to enable two pipes to be connected together in each case.

The two coupling portions do not have cylindrical contacting surfaces but curved contacting surfaces. The outer coupling portion has an interior surface which is curved in the longitudinal direction, while the inner coupling portion has an exterior surface which is curved in the longitudinal direction, the surfaces of the inner and outer coupling portions being of different curvatures.

As well as this, the pipe according to the invention is also distinguished by the fact that the maximum inside diameter of the curved interior surface of the outer coupling portion is smaller than the maximum outside diameter of the curved exterior surface of the inner coupling portion. What is achieved in this way is that a preloading is produced when the individual pipes are plugged together. However, because the outlines of the two coupling portions are not straight but curved and of different curvatures, the contact which occurs between the contacting surfaces of the coupling portions which are joined to one another cannot cover a relatively large area but can only cover a relatively small area and may possibly be only a line contact.

In trials, it has been found that contact covering a relatively small area, and possibly even a line contact, between the pipes gives relatively good sealing when the pipes are subject to a preloading. With the contact covering a relatively small area, and possibly even the line contact, between the coupling portions of the pipes, this sealing is maintained even when the radiuses of the coupling portions differ from the desired radiuses due not only to manufacturing tolerances but also to subsequent deformations of the material.

The particular design of the coupling portions of the pipe according to the invention ensures on the one hand that the pipes can be plugged together easily, at least with suitable technical aids, and on the other hand that they are subject to an adequate preloading.

The sealing of the pipes is further increased if the medium which is conveyed through the pipeline is a liquid medium which is itself under pressure. This results in a further increase in the preloading, thus causing the two coupling portions to be pressed against one another even harder.

Basically, it is immaterial what the outline of the coupling portions is in the longitudinal direction provided it is ensured that the coupling portions come into contact with one another not over the entire area but preferably only in a relatively small area and possibly only along a line of contact. Advantageously, the curvature of the curved surfaces of the inner and outer coupling portions in the longitudinal direction is in the same direction for at least part of their length, i.e. the curvatures of the coupling portions are defined by radiuses but the radiuses of the inner and outer coupling portions differ from one another.

In a preferred embodiment, the radius of curvature of the curved surface of the outer coupling portion is larger than the radius of curvature of the curved surface of the inner coupling portion, i.e. the outer contacting surface is more sharply curved than the inner connecting surface. Basically, it is however also possible for the curved surface of the outer coupling portion to be of a smaller radius of curvature than the curved surface of the inner coupling portion.

In another preferred embodiment, the outer coupling portion has an interior surface which curves outwards in the longitudinal direction, i.e. a trough-like depression is formed in the wall of the pipe in this region, and the inner coupling portion has an exterior surface which curves outwards in the longitudinal direction. Basically, it is however also possible for the outer coupling portion to have an interior surface which curves inwards and for the inner coupling portion to have an exterior surface which curves inwards.

In another, particularly preferred, embodiment, latching means are provided on the inner and outer coupling portions, which latching means are so designed that the coupling portions latch together when the pipes are plugged together. The pipes are thus secured together in the longitudinal direction. It has been found in practice that with the latching means the tractive force can be increased to separate the pipes again. The latching means are not however absolutely essential to ensure that the requisite sealing exists.

In a preferred embodiment, the latching means comprise a projecting nose which is provided at the free end of the inner coupling portion and a corresponding recess which is provided at the non-free end of the outer coupling portion. It is however also possible for the projecting nose to be provided on the outer coupling portion and the recess in the inner coupling portion. When the pipes are plugged together, the projecting nose snaps into the recess by latching thereinto. The pipes are secured together in the longitudinal direction in this way. Undercuts may be provided on the projecting nose and/or in the recess. Bevels which simplify the joining together of the pipes are preferably provided at the free ends of the coupling portions.

Before the pipes are joined together, the inner coupling portion and the outer coupling portion are preferably of the same outside diameter and inside diameter respectively as the central portion of the pipe, which means that the pipe is of the same inside and outside diameters for its entire length. When the pipes are joined together to form the pipeline, a slight outward arching occurs due to the preloading in the socket region. With thin-walled pipes however, an increase in the wall thickness of the pipes in the socket region may be of advantage. What is then done is, in particular, to increase the inside diameter of the inner coupling portion, the outside diameter of the pipe not being increased.

The pipe is preferably a pipe of plastics material which can be inexpensively produced in large numbers by the known manufacturing processes. The plastics materials which are suitable for the media to be transported are familiar to the person skilled in the art. If corrosive media are to be conveyed through the pipeline, the plastics materials have to be resistant to these corrosive media. The plastics materials should also have adequate abrasion resistance.

The method according to the invention of connecting two pipes according to the invention is distinguished by the fact that there is no need for the additional step of welding the pipes. To connect the pipes, the inner coupling portion of one pipe is simply inserted in the outer coupling portion of the other pipe.

The pipes according to the invention are found to be especially advantageous particularly when a medium which is conveyed through the pipeline is under pressure, which means that the sealing is further increased due to the higher pressure with which the coupling portions are pressed together. This is an advantage particularly because it is precisely when media under pressure are being fed that particularly demanding requirements are set for the sealing. The generation of an internal pressure is not however absolutely essential to make the seal. The pipes according to the invention are also intended for non-pressurised applications.

An embodiment of the invention will be explained in what follows by reference to the drawings.

In the drawings:

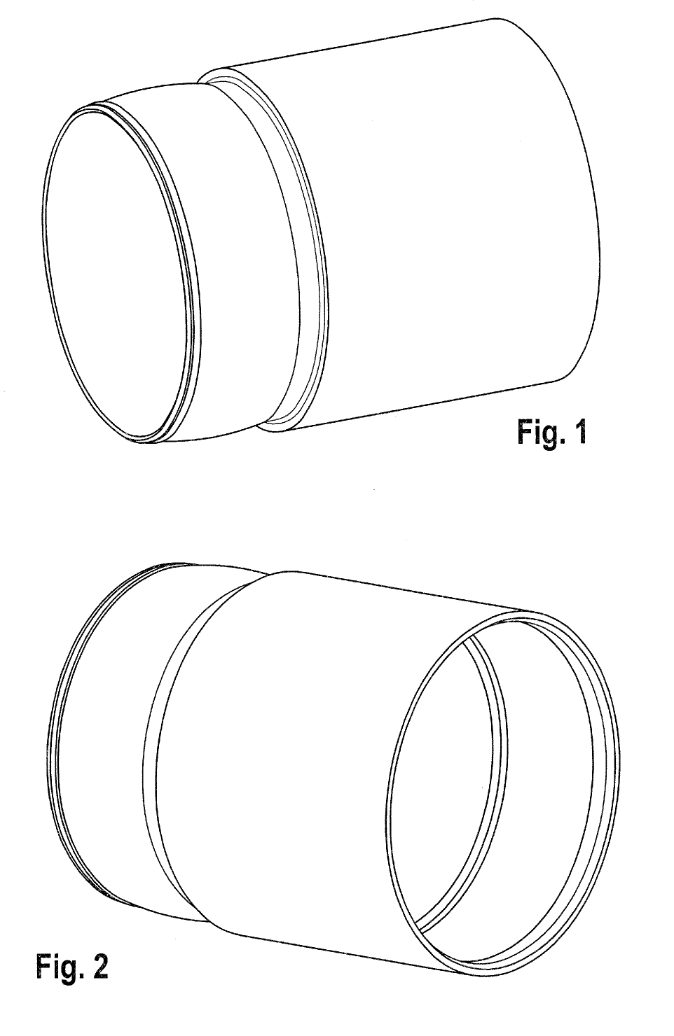

FIG. 1 is a perspective view of the pipe according to the invention, looking from a direction in which the inner coupling portion in particular of the pipe can be clearly seen,

FIG. 2 is a perspective view of the pipe according to the invention, looking from a direction in which the outer coupling portion in particular can be clearly seen,

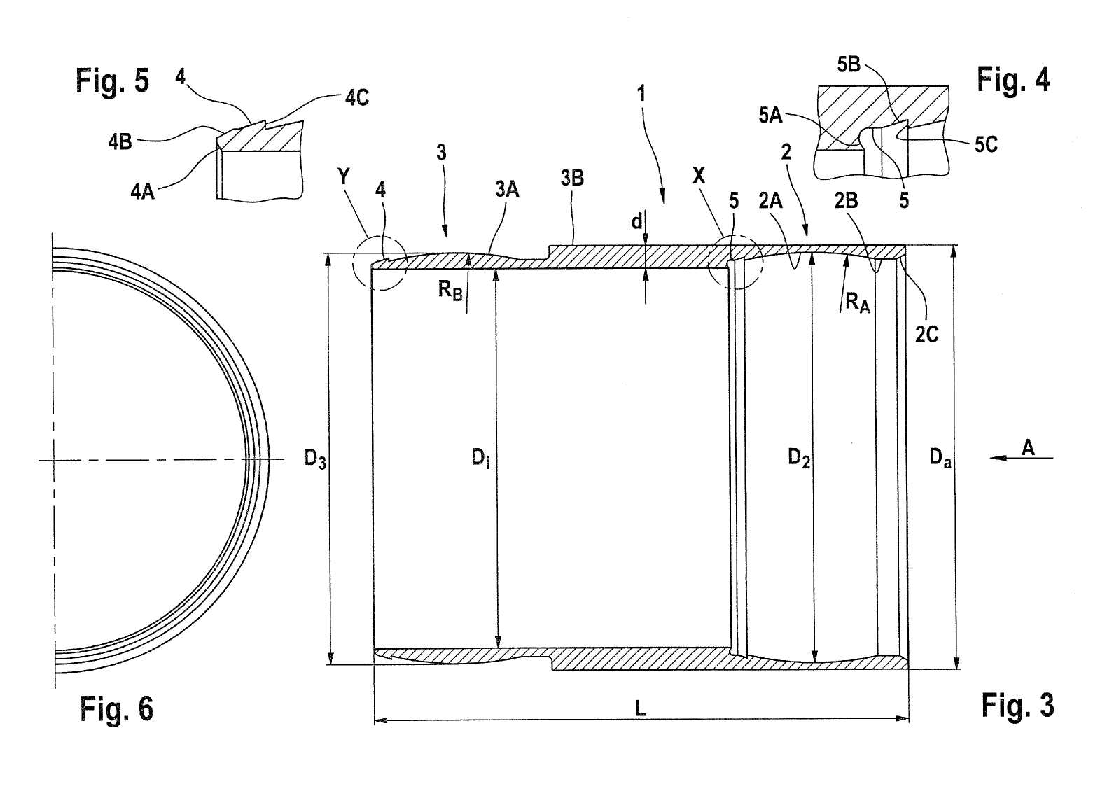

FIG. 3 is a longitudinal section through the pipe according to the invention,

FIG. 4 is an enlarged view of detail X of FIG. 3,

FIG. 5 is an enlarged view of detail Y of FIG. 3,

FIG. 6 is a view looking in the direction of arrow A in FIG. 3,

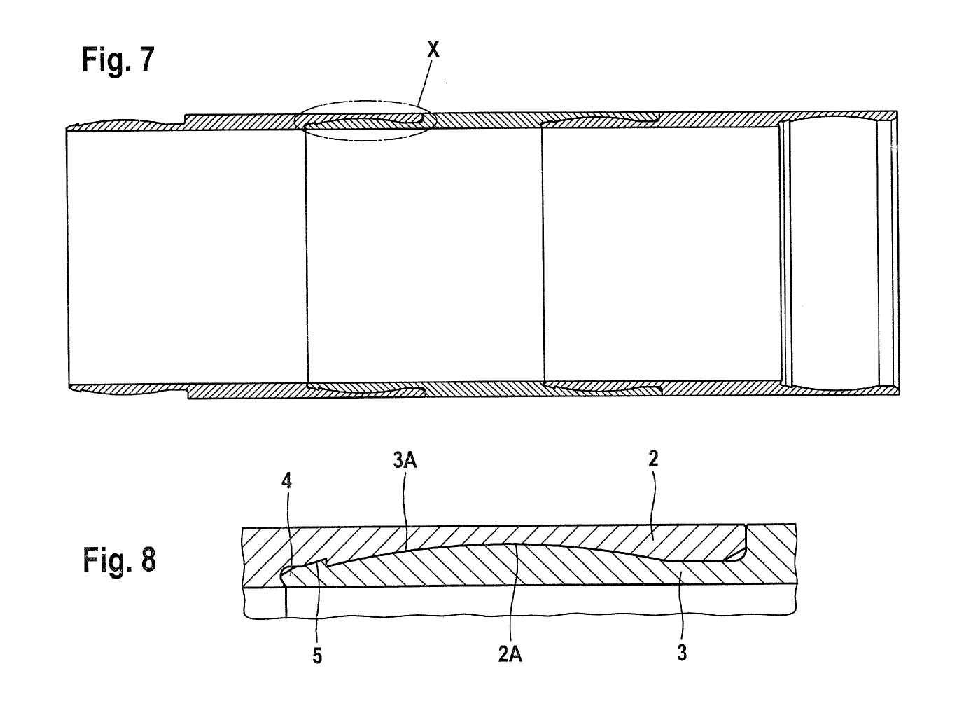

FIG. 7 is a section showing two pipes which have been connected together,

FIG. 8 is an enlarged view of detail X of FIG. 7.

FIGS. 1 and 2 are perspective views of the pipe according to the invention, while FIG. 3 is a section through the pipe.

The pipe according to the invention is a pipe of plastics material which is of an outside diameter Dₐ. The outside diameter is for example 242 mm. The pipe has a wall thickness d which is for example 13 mm. The pipe is of a length L which is for example 2000 mm. The pipe is shown shortened in the drawings. The drawings show only one embodiment. The pipes may however also be of other dimensions, such for example as of an outside diameter of up to 2000 mm.

The pipe has an inner coupling portion 3 and an outer coupling portion 2, whose wall thicknesses are each less than the wall thickness d of the central portion 1 of the pipe. The outer coupling portion 2 is of an outside diameter which remains the same in the longitudinal direction and which is equal to the outside diameter Dₐ of the central portion 1 of the pipe, while the inner coupling portion 3 is of an inside diameter which remains the same in the longitudinal direction and which is equal to the inside diameter Dᵢ of the central portion 1 of the pipe. When the pipes are joined together however, a slight outward arching appears due to the preloading. Strengthening may also be necessary in the socket region if the pipes are of only a small wall thickness.

The pipes according to the invention are plugged together to form the pipeline. When this is done, the outer coupling portion 2 of the first pipe, which is in the form of a receiving portion, is plugged onto the inner coupling portion 3 of the second pipe, which is in the form of an insertion portion. The outer coupling portion of the second pipe is plugged in turn onto the inner coupling portion of the third pipe (FIG. 7).

The outer coupling portion 2 of the pipe has an outwardly curved interior surface 2A whose curvature remains the same in the longitudinal direction of the pipe. It is also possible for the curvature to be of different radiuses in the axial direction. The curvature is defined by a radius R_{A}. In the present embodiment the radius R_{A} is for example 180.84 mm. Only the end portion 2B of the outer coupling portion 2 is of a cylindrical form. The outer coupling portion 2 has at its free end a bevel 2C so that the inner coupling portion 3 can be slid easily into the outer coupling portion 2 when the pipes are being joined together.

The inner coupling portion 3 of the pipe has an outwardly curved exterior surface 3A whose curvature once again remains the same in the longitudinal direction of the pipe, but may also vary. The curvature is once again defined by a radius R_{B}, but this radius may be smaller than the radius R_{A} of the curvature of the outer coupling portion 2. In the present embodiment the radius R_{B} is for example 160 mm. The ratio of the radiuses R_{A} and R_{B} may however also be a different one.

The outwardly curved exterior surface 3A of the inner coupling portion 3 merges into a cylindrical region 3B whose length is the same as the length of the cylindrical end portion 2B of the outer coupling portion 2. The central portion 1 of the pipe continues on from the cylindrical region 3B of the inner coupling portion 3.

To allow a preloading to be obtained when the pipes are plugged together, the maximum inside diameter D₂ of the outer coupling portion 2 is smaller than the maximum outside diameter D₃ of the inner coupling portion 3. In the present embodiment the diameter D₂ is for example 233 mm whereas the diameter D₃ is for example 234 mm. With a larger difference between the two diameters D₂ and D₃, the preloading can be further increased.

The coupling portions 2 and 3 have latching means to secure the pipes together axially when they have been plugged together. The latching means comprise a projecting nose 4 which is formed at the free end of the inner coupling portion 3 and a corresponding recess 5 which is formed at the non-free end of the outer coupling portion 2. The recess 5 is situated in that region of the pipe in which the outer coupling portion 2 merges into the central portion 1 of the pipe. FIG. 4 is an enlarged view of the recess 5 while FIG. 5 is an enlarged view of the latching nose 4.

The latching nose 4 has an inclined face 4A which faces forward in the drawings and which extends obliquely inwards from the front end of the pipe (FIG. 5). Following on from the front end of the inclined face 4A there is an outward facing inclined face 4B which extends obliquely outwards from the front end of the pipe. The outward facing inclined face 4B drops back down to the radius of curvature 3A, thus producing a face for abutment 4C. The correspondingly shaped recess 5 in which the latching nose 4 engages by snapping into it has a complementary front inclined face 5A from which a complementary outer inclined face 5B follows on via a radius, the complementary outer inclined face 5B ending in a complementary face for abutment 5C.

FIG. 8 is an enlarged view showing the region in which two pipes are plugged together. It can be seen that the latching nose 4 of one pipe engages in the recess 5 in the other pipe by latching, because the two complementary faces for abutment 4A and 5C bear against one another. The pipes are secured against deforming in the axial direction by this means. It does not however produce contact over their full area between the curved surfaces 2A, 3A of the two coupling portions 2, 3 of the pipes, due to the different radiuses of curvature R_{A}, R_{B}. Instead there is a relatively small area of contact only in the central region of the plugged-together joint. Due to the larger maximum outside diameter D₃ of the inner coupling portion 3 and the smaller maximum inside diameter D₂ of the outer coupling portion 2, the intended preloading, which is important to allow the requisite sealing of the pipeline to be achieved, is produced when the pipes are plugged together.

The two front complementary inclined faces 4A and 5A stop the inner coupling portion 3 from relaxing inwards, which might cancel out the preloading, particularly in a state where there is no pressure. Due to the properties of the material, a deformation of this kind may occur particularly when there are changes in temperature. When the pipes are plugged together, the outer inclined face 4B of the inner coupling portion 3 slides across the bevel 2C on the outer coupling portion 2, which means that the pipes can be plugged together more easily.

1. Pipe for a pipeline comprising a plurality of pipes to be connected together having an outer coupling portion (2), which is in the form of a receiving portion to receive the inner coupling portion (3), which is in the form of an insertion portion, of another pipe belonging to the pipeline, and an inner coupling portion (3), which is in the form of an insertion portion for insertion in the outer coupling portion (2), which is in the form of a receiving portion, of another pipe belonging to the pipeline, characterised in that:
the outer coupling portion (2) has an interior surface (2A) which is curved in the longitudinal direction, and the inner coupling portion (3) has an exterior surface (3A) which is curved in the longitudinal direction, the surfaces of the inner and outer coupling portions (2, 3) being of different curvatures (R_{A}, R_{B}),
the maximum inside diameter (D₂) of said curved interior surface (2A) of the outer coupling portion (2) being smaller than the maximum outside diameter (D₃) of said curved exterior surface (3A) of the inner coupling portion (3),
thus producing a preloading between the coupling portions which are plugged together, when the inner coupling portion of another pipe belonging to the pipeline is inserted in the outer coupling portion, or when the outer coupling portion of another pipe belonging to the pipeline is plugged onto the inner coupling portion.

2. Pipe according to claim 1, characterised in that said curved interior surface (2A) of the outer coupling portion (2) is of a curvature which remains the same in the longitudinal direction.

3. Pipe according to claim 1, characterised in that said curved exterior surface (3A) of the inner coupling portion (3) is of a curvature which remains the same in the longitudinal direction.

4. Pipe according to claim 1, characterised in that the radius of curvature (R_{A}) of said curved surface (2A) of the outer coupling portion (2) is larger than the radius of curvature (R_{B}) of said curved surface (3) of the inner coupling portion (3).

5. Pipe according to claim 1, characterised in that said interior surface (2A) of the outer coupling portion (2) curves outwards in the longitudinal direction, and said exterior surface (3A) of the inner coupling portion (3) curves outwards in the longitudinal direction.

6. Pipe according to claim 1, characterised in that latching means (4, 5) are provided on the outer coupling portion (2) and inner coupling portion (3), which said latching means (4, 5) are so designed that the inner coupling portion of another pipe belonging to the pipeline can be inserted in the outer coupling portion to latch thereinto, or the outer coupling portion of another pipe belonging to the pipeline can be plugged onto the inner coupling portion to latch thereonto, thus securing together in the longitudinal direction the pipes which have been connected together.

7. Pipe according to claim 6, characterised in that a projecting nose (4) is provided at the free end of the inner coupling portion (3) and a recess (5) is provided at the non-free end of the outer coupling portion (3), thus causing said projecting nose (4) to latch into said recess (5) by snapping thereinto, when the inner coupling portion of another pipe belonging to the pipeline is inserted in the outer coupling portion, or when the outer coupling portion of another pipe belonging to the pipeline is plugged onto the inner coupling portion.

8. Pipe according to claim 1, characterised in that the outer coupling portion (2) is of the same outside diameter (Dₐ) as the central portion (1) of the pipe.

9. Pipe according to claim 1, characterised in that the inner coupling portion (3) is of the same inside diameter (Dᵢ) as the central portion (1) of the pipe.

10. Pipe according to claim 1, characterised in that the pipe is a pipe of plastics material.

11. Pipeline having a plurality of pipes according to claim 1.

12. Method of connecting at least two pipes according to claim 1, characterised in that the inner coupling portion of the second pipe is inserted in the outer coupling portion of the first pipe, or the outer coupling portion of the second pipe is plugged onto the inner coupling portion of the first pipe.

13. Method according to claim 12, characterised in that an internal pressure is applied in the two pipes by conveying a medium under pressure through the two pipes.
